(19) United States
(12) Patent Application Publication
(10) Pub. No.: US 2010/0064255 A1
(43) Pub. Date: Mar. 11, 2010

(54) CONTEXTUAL MENUS IN AN ELECTRONIC DEVICE

(75) Inventors: Benjamin Andrew Rottler, Burlingame, CA (US); Policarpo Wood, Cupertino, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/205,087

(22) Filed: Sep. 5, 2008

(51) Int. Cl. G06F 3/048

(52) U.S. Cl. 715/821; 715/810

(57) ABSTRACT

A system and method for displaying menus of selectable options to a user are provided. The menus may include options that are contextually related to a current mode of the device to provide relevant options to a user. The electronic device modes may include, for example, a media mode, a radio mode, a workout mode, a calendar or event mode, a clock mode, a stopwatch mode, or any other suitable mode. To further enhance a user's experience, the displayed menus may not cover the entirety of the screen such that a portion of the content associated with a current mode or application may be visible, thus providing context to the displayed options.

### BACKGROUND OF THE INVENTION

This invention relates to the display of contextual menus in a portable electronic device.

A user of an electronic device may provide inputs to direct the device to perform particular operations using different approaches. In some embodiments, the electronic device may include an extensive input mechanism for allowing a user to provide a variety of inputs, where each input may be associated with a particular electronic device operation.

As the number of operations available to a user of the electronic device increases, a user may not be able to control each electronic device operation using a simple input or input sequence (e.g., key press or key press sequence) of the input mechanism. Similarly, if an electronic device has a limitation to its input mechanism, for example due to the size or portability of the electronic device, the limited number of available inputs may not suffice to control each available electronic device operation.

To ensure that the user may fully control the electronic device, different selectable options may be displayed. For example, an electronic device application may include a menu bar that a user may select to access different options associated with the application. The available options may tend to be generic, however. In addition, the menus or displayed options may obscure the underlying content displayed by the electronic device, which may impair a user's ability to interact with the electronic device. These limitations become even more apparent and cumbersome when applied to portable electronic devices with limited input mechanisms or limited displays.

### SUMMARY OF THE INVENTION

Systems, methods and computer-readable media for displaying menus with options related to a current mode of an electronic device are provided.

A portable electronic device for displaying a menu with context-specific options may be provided. The electronic device may display non-selectable content associated with a current mode of an electronic device. For example, the electronic device may display information regarding played back media or a user's workout. The current mode may include, for example, one of a media, recording, audio book, radio, workout, calendar, event, clock, and stopwatch mode. The electronic device may detect an input from an input mechanism (e.g., an extended press of a button). In response to detecting the input, the electronic device may detect the current mode of the device and identify at least one option associated only with the detected current mode. The electronic device may then generate a menu that includes the identified at least one option and overlay the generated menu on the displayed content such that at least a portion of the content remains visible underneath the menu.

A portable electronic device for displaying a menu with context-specific options may be provided. The electronic device may include a processor, a display and an input mechanism. The processor may direct the display to display content associated with a particular mode of the electronic device. The processor may receive an indication from the input mechanism that an input was received from the user. The received input may not be associated with a selectable option displayed by the display (e.g., if no selectable options are displayed on the display). In response to receiving the input, the processor may detect the particular mode of the device and identify at least one operation associated only with the particular mode. The processor may then direct the display to display a menu that includes an option for the electronic device to perform the at least one operation.

### BRIEF DESCRIPTION OF THE DRAWINGS

The above and other features of the present invention, its nature, and various advantages will be more apparent upon consideration of the following detailed description, taken in conjunction with the accompanying drawings, in which like reference characters refer to like parts throughout, and in which:

FIG. 1 is a schematic view of an illustrative electronic device for providing displays of information in accordance with one embodiment of the invention;

FIG. 2 is a schematic view of an illustrative display screen of a media mode in accordance with one embodiment of the invention;

FIG. 3 is a schematic view of an illustrative display screen in which contextual selectable options for media playback are displayed in accordance with one embodiment of the invention;

FIG. 4 is a schematic view of an illustrative display screen of a playlist in media mode in accordance with one embodiment of the invention;

FIG. 5 is a schematic view of an illustrative display screen in which contextual selectable options for a playlist are displayed in accordance with one embodiment of the invention;

FIG. 6 is a schematic view of an illustrative display screen of a recording mode in accordance with one embodiment of the invention;

FIG. 7 is a schematic view of an illustrative display screen in which contextual selectable options for recording are displayed in accordance with one embodiment of the invention;

FIG. 8 is a schematic view of an illustrative display screen of an audio book mode in accordance with one embodiment of the invention;

FIG. 9 is a schematic view of an illustrative display screen in which contextual selectable options for an audio book are displayed in accordance with one embodiment of the invention;

FIG. 10 is a schematic view of an illustrative display of a radio mode in accordance with one embodiment of the invention;

FIG. 11 is a schematic view of an illustrative display screen in which contextual selectable options for a radio mode are displayed in accordance with one embodiment of the invention;

FIG. 12 is a schematic view of another illustrative display screen in which contextual selectable options for a radio mode are displayed in accordance with one embodiment of the invention;

FIG. 13 is a schematic view of an illustrative display of a workout in a workout mode in progress in accordance with one embodiment of the invention;

FIG. 14 is a schematic view of an illustrative display screen having contextual selectable options for an ongoing workout in a workout mode in accordance with one embodiment of the invention;

FIG. 15 is a schematic view of an illustrative display of a workout history menu in a workout mode in accordance with one embodiment of the invention;

FIG. 16 is a schematic view of an illustrative display screen having contextual selectable options for a workout history in a workout mode in accordance with one embodiment of the invention;

FIG. 17 is a schematic view of an illustrative display of a workout totals menu in a workout mode in accordance with one embodiment of the invention;

FIG. 18 is a schematic view of an illustrative display screen having contextual selectable options for a total workout screen of a workout mode in accordance with one embodiment of the invention;

FIG. 19 is a schematic view of an illustrative display screen for viewing a calendar event or task in a calendar or task mode in accordance with one embodiment of the invention;

FIG. 20 is a schematic view of an illustrative display screen having contextual selectable options for an event in a calendar or task mode in accordance with one embodiment of the invention;

FIG. 21 is a schematic view of an illustrative display screen for viewing a clock in a clock mode in accordance with one embodiment of the invention;

FIG. 22 is a schematic view of an illustrative display screen having contextual selectable options for a single displayed clock in accordance with one embodiment of the invention;

FIG. 23 is a schematic view of an illustrative display screen for viewing several clocks in a clock mode in accordance with one embodiment of the invention;

FIG. 24 is a schematic view of an illustrative display screen having contextual selectable options for several displayed clocks in accordance with one embodiment of the invention;

FIG. 25 is a schematic view of an illustrative display screen showing a stopwatch in a stopwatch mode in accordance with one embodiment of the invention;

FIG. 26 is a schematic view of an illustrative display screen having contextual selectable options for a stopwatch mode in accordance with one embodiment of the invention;

FIG. 27 is a schematic view of an illustrative display screen showing a stopwatch log in a stopwatch mode in accordance with one embodiment of the invention;

FIG. 28 is a schematic view of an illustrative display screen having contextual selectable options for editing a stopwatch log in accordance with one embodiment of the invention; and

FIG. 29 is a flow chart of an illustrative process for displaying a contextual menu associated with a current mode in accordance with one embodiment of the invention.

### DETAILED DESCRIPTION

Systems and methods for displaying menus of selectable options to a user are provided. The menus may include options that are contextually related to a current mode of the device to provide relevant options to a user. To further enhance a user's experience, the displayed menus may not cover the entirety of the screen such that a portion of the content associated with a current mode or application may be visible, thus providing context to the displayed options.

The electronic device may display several menus with selectable options associated with different operations to allow a user to control the electronic device operation. The menus may be displayed in any suitable manner, including for example as overlays on other displays. In some embodiment, the displayed menu may not cover the entirety of a display. For example, the displayed menu may be overlaid over a portion (e.g., one half or two thirds) of the display. To bring the user's attention to the menu, the information displayed underneath the overlay may be darkened or become translucent so that a user may view the information underneath the menu to provide context for the menu options.

The displayed menu may include any suitable selectable option. In some embodiments, the menu may include generic or general options that may be accessible from one or more modes or modules of the electronic device (e.g., a Main Menu and Exit options). In some embodiments, the displayed menu may include one or more options that are contextually related to the information displayed underneath the menu or to the mode or module of the electronic device when the menu is requested. For example, in a media mode the displayed options may be related to particular media being played back. As another example, in a clock mode the displayed options may be related to adding a new clock for display by the device.

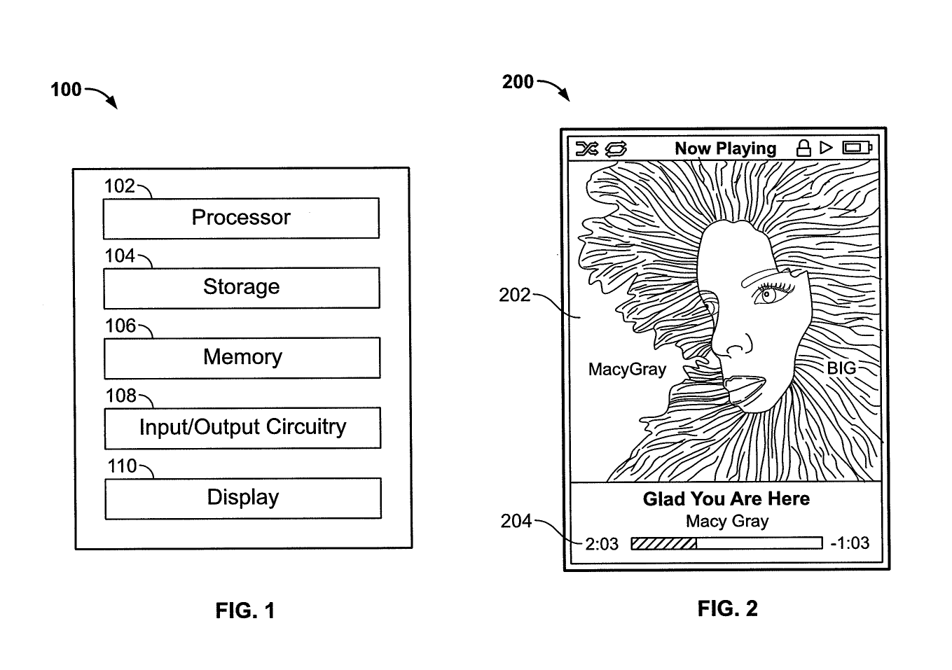

FIG. 1 is a schematic view of an illustrative electronic device for providing displays of information in accordance with one embodiment of the invention. Electronic device 100 may include processor 102, storage 104, memory 106, input/output circuitry 108, and display 110. In some embodiments, one or more of electronic device components 100 may be combined or omitted (e.g., combine storage 104 and memory 106). In some embodiments, electronic device 100 may include other components not combined or included in those shown in FIG. 1 (e.g., communications circuitry, a power supply, bus, or input mechanism), or several instances of the components shown in FIG. 1. For the sake of simplicity, only one of each of the components is shown in FIG. 1.

Processor 102 may include any processing circuitry operative to control the operations and performance of electronic device 100. For example, processor 100 may be used to run operating system applications, firmware applications, media playback applications, media editing applications, or any other application. In some embodiments, a processor may drive a display and process inputs received from a user interface.

Storage 104 may include, for example, one or more storage mediums including a hard-drive, solid state drive, flash memory, permanent memory such as ROM, any other suitable type of storage component, or any combination thereof. Storage 104 may store, for example, media data (e.g., music and video files), application data (e.g., for implementing functions on device 100), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that may enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate electronic device applications, or any other type of data that may be stored in storage 104. In some embodiments, memory 106 and storage 104 may be combined as a single storage medium.

Input/output circuitry 108 may be operative to convert (and encode/decode, if necessary) analog signals and other signals into digital data. In some embodiments, input/output circuitry 108 can also convert digital data into any other type of signal, and vice-versa. For example, input/output circuitry 108 may receive and convert physical contact inputs (e.g., from a multi-touch screen), physical movements (e.g., from a mouse or sensor), analog audio signals (e.g., from a microphone), or any other input. The digital data can be provided to and received from processor 102, storage 104, memory 106, or any other component of electronic device 100. Although input/output circuitry 108 is illustrated in FIG. 1 as a single component of electronic device 100, several instances of input/output circuitry can be included in electronic device 100.

Electronic device 100 may include any suitable mechanism or component for allowing a user to provide inputs to input/output circuitry 108. For example, electronic device 100 may include any suitable input mechanism, such as for example, a button, keypad, dial, a click-wheel, or a touch screen. In some embodiments, electronic device 100 may include a capacitive sensing mechanism, or a multi-touch capacitive sensing mechanism. Some sensing mechanisms are described in commonly owned Hotelling et al. U.S. Published Patent Application No. 2006/0026521, published Feb. 2, 2006, entitled “Gestures for Touch Sensitive Input Device,” and Hotelling et al. U.S. Published Patent Application No. 2006/0026535, published Feb. 2, 2006, entitled “Mode-Based Graphical User Interfaces for Touch Sensitive Input Device,” both of which are incorporated herein in their entirety.

In some embodiments, electronic device 100 can include specialized output circuitry associated with output devices such as, for example, one or more audio outputs. The audio output may include one or more speakers (e.g., mono or stereo speakers) built into electronic device 100, or an audio component that is remotely coupled to electronic device 100 (e.g., a headset, headphones or earbuds that may be coupled to communications device with a wire or wirelessly).

Display 110 may be operative to provide displays of information to the user, for example from outputs received from I/O circuitry 108. For example, display 110 may include a screen (e.g., an LCD screen) that is incorporated in electronics device 100. As another example, display 110 may include a movable display or a projecting system for providing a display of content on a surface remote from electronic device 100 (e.g., a video projector). In some embodiments, display 100 can include or may be coupled to a coder/decoder (Codec) to convert digital media data into analog signals. For example, display 100 (or other appropriate circuitry within electronic device 100) may include video Codecs, audio Codecs, or any other suitable type of Codec.

Display 100 also can include display driver circuitry, circuitry for driving display drivers, or both. Display 100 may be operative to display content (e.g., media playback information, application screens for applications implemented on the electronic device, information regarding ongoing communications operations, information regarding incoming communications requests, menus with selectable options for performing electronic device operations, or device operation screens) under the direction of processor 102.

In some embodiments, the electronic device may include communications circuitry for communicating with other devices or with one or more servers using any suitable communications protocol. Electronic device 100 may include one more instances of communications circuitry for simultaneously performing several communications operations using different communications networks. For example, communications circuitry may support Wi-Fi (e.g., a 802.11 protocol), Ethernet, Bluetooth™ (which is a trademark owned by Bluetooth Sig, Inc.), radio frequency systems, cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), any other communications protocol, or any combination thereof.

In some embodiments, electronic device 100 may include a bus operative to provide a data transfer path for transferring data to, from, or between control processor 102, storage 104, memory 106, input/output circuitry 108, sensor 110, and any other component included in the electronic device.

FIGS. 2-28 depict representative interactive user interface displays according to embodiments of the invention. In some embodiments, a processor, other circuitry, or combination thereof can be configured to present the interactive user interface displays of FIGS. 2-28 on a display screen or other user interface component. It is important to note that the displays shown in FIGS. 2-28 may be unique in that they may be optimized to provide advanced interactive functionality, despite the limitations of relatively simple user input devices, such as a click-wheel or six button remote control or other limited interface. Designing interactive displays that are used in conjunction with these types of simple user input devices is generally a more complicated process than designing displays that are used with other user input devices (such as a mouse, keyboard, cellular telephone keypad, standard remote control that has more than 6 buttons, etc.). Simple user input devices, though easy for users to use, may limit how a user can navigate within a display and among multiple displays.

Using the electronic device display, the processor may provide different types of information to the user. In some embodiments, the electronic device may enable different modes or modules in response to user instructions or requests. For example, the electronic device may enable a media mode, a radio mode (e.g., available when an accessory device is coupled to the electronic device), a workout mode (e.g., available when an accessory device is coupled to the electronic device), a calendar or event mode, a clock mode, a stopwatch mode, or any other suitable mode. One or more applications may be available to the user when a particular mode is enabled. For example, in a workout mode, the electronic device may provide the user with access to a media playback application (e.g., for playing music during the workout) and a workout application (e.g., for monitoring the progress of a user's workout and for receiving communications from a transmitter). Each mode may be associated with operations or options that are generic (e.g., available to some or all modes) and other operations or options that are contextually related to the mode. To enhance a user's experience, the electronic device may provide a user with access to contextually relevant options or operations based on the current mode of the device.

FIG. 2 is a schematic view of an illustrative display screen of a media mode in accordance with one embodiment of the invention. Display 200 may include cover art 202 and playback bar 204 for controlling media playback, but no menu or selectable options overlaid on a portion of display 200 (e.g., a menu having a listing of selectable options). Using standard electronic device inputs (e.g., the inputs available from a click-wheel), a user may control some media mode operations from display 200, including for example playback and volume for media. Other operations related to the media mode, however, may not be easily accessible. In particular, operations accessed by selecting an option displayed on a screen (e.g., operations not associated with particular buttons of the input mechanism of the electronic device) cannot be easily accessed because the necessary options are not displayed in display 200. For example, display 200 may not include options for accessing information related to the currently played back media or for organizing the media in a playlist.

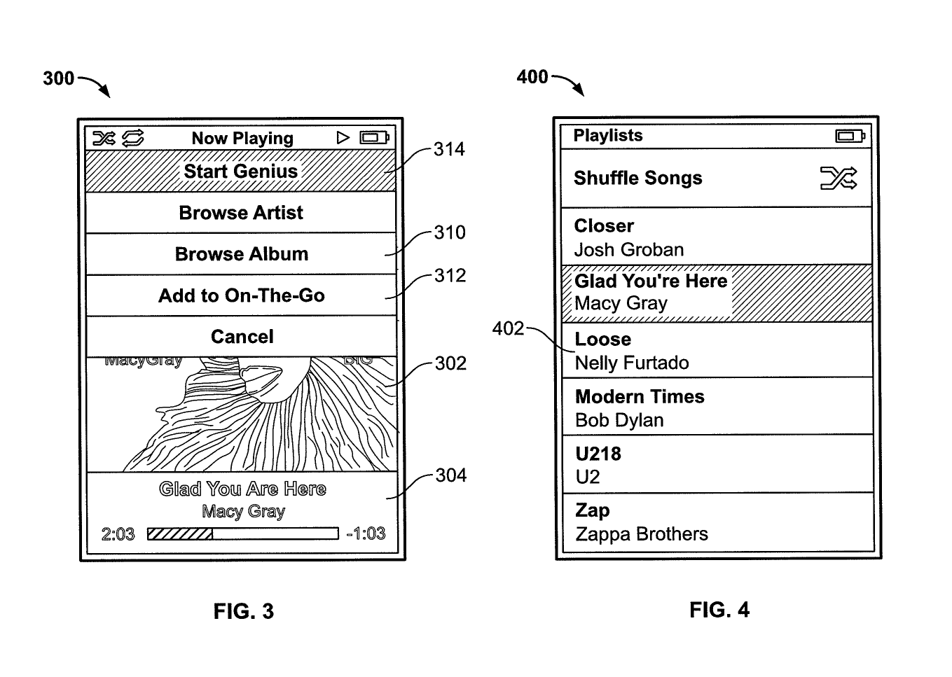

FIG. 3 is a schematic view of an illustrative display screen in which contextual selectable options for media playback are displayed in accordance with one embodiment of the invention. Display screen 300 may include menu 310 overlaid on or adjacent to cover art 302 and playback bar 304. The electronic device may display menu 310 at any suitable time or in response to any suitable instruction. For example, the electronic device may detect a particular button press (e.g., an extended center button press), combination of button presses (e.g., a center button and menu button press), a particular swipe or movement on a touch-sensitive input mechanism, or any other suitable input for directing the electronic device to display menu 310. In response to detecting the input associated with displaying menu 310, the electronic device may overlay menu 310 on display 300.

Menu 310 may be displayed such that at least a portion of the content displayed before the display of menu 310 is still be visible to the user. To call attention to menu 310 while providing context for the menu, the electronic device may change the display properties of the previously displayed content (e.g., the content remaining underneath menu 310). In some embodiments, the electronic device may darken, change the transparency, color or font of the content, provide an indication of depth (e.g., using shadows) of the content, or otherwise modify the display of the content. In some embodiments, the electronic device may apply shadows (e.g., drop shadows) to menu 310 to provide depth over the previously displayed content. In the example of FIG. 3, cover art 302 and playback bar 304 may be darkened (e.g., the luminosity of the content may be changed) and made translucent and menu 310 may include a drop shadow. By overlaying a menu on content to which the menu options are related, the electronic device may provide context for the menu items. By using different display properties for the menu and the content on which the overlay is displayed, the electronic device may call the user's attention to the menu.

The electronic device may use any suitable approach for adding menu 310 to display 300. For example, the electronic device may provide an animation for transitioning from a line at the top of display 300 to menu 310 (e.g., an expanding or growing menu extending from a side of display 300). In some embodiments, menu 310 may grow from a single point (e.g., simultaneously expanding towards the center and edges of the display). The electronic device may use any suitable animation to remove menu 310 from display 300, including for example the same or similar animation (e.g., a reverse animation) as that used to add menu 310 to display 300. To further enhance the user's experience, an audio transition (e.g., an audio clip) may be played when the menu is added or removed from display 300.

Menu 310 may include several selectable options 312. The user may select an option 312 by navigating highlight region 314 over the option and providing a selection instruction. Menu 310 may include any suitable option 312, including for example generic options not related specifically to the mode of the electronic device or information displayed underneath menu 310 (e.g., a Cancel option). Menu 310 may also include options for operations that are contextually related to the mode of the electronic device or the media or data displayed or accessed (e.g., played back) by the device. In the example of FIG. 3, menu 310 may include Start Genius and Add to On-the-go options (e.g., options related to the media mode), Browse Album and Browse Artist options (e.g., options related to particular data or media in use by the electronic device).

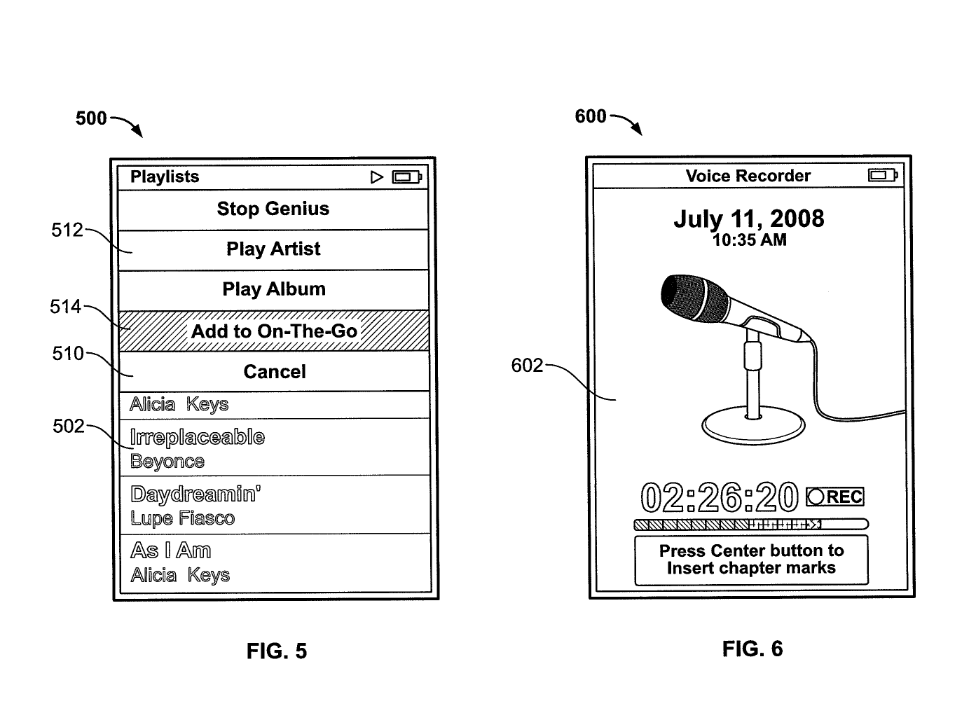

FIG. 4 is a schematic view of an illustrative display screen of a playlist in media mode in accordance with one embodiment of the invention. Display 400 may include listings 402 of media available for playback and placed in a playlist. Using standard electronic device inputs (e.g., the inputs available from a click-wheel), a user may control some playback operations from display 400, including for example controlling playback of a particular media item or controlling the volume of the played back media. Other operations related to the media mode, however, may not be easily accessible. FIG. 5 is a schematic view of an illustrative display screen in which contextual selectable options for a playlist are displayed in accordance with one embodiment of the invention. Display screen 500 may include menu 510 overlaid on or adjacent to listings 502. Menu 510 may include some or all of the features described in connection with menu 310 (FIG. 3). Menu 510 may include several options 512 that a user may select by navigating highlight region 514 over the option and providing a selection instruction. Menu 510 may include any suitable option 512, including for example generic options not related specifically to the mode of the electronic device or information displayed underneath menu 510 (e.g., a Cancel option). Menu 510 may also include options for operations that are contextually related to the mode of the electronic device or the media or data displayed or accessed (e.g., played back) by the device. In the example of FIG. 5, menu 510 may include a Stop Genius and Add to On-the-go options (e.g., option related to the shuffle feature of a media mode), Play Artist and Play Album options (e.g., options related to particular data or media in use by the electronic device).

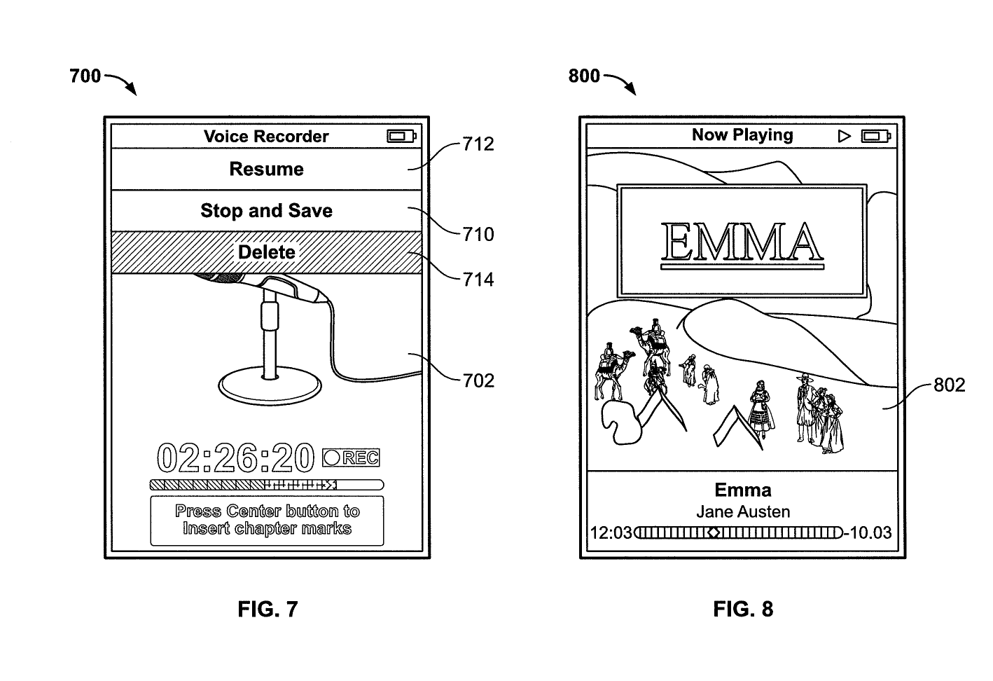

In some embodiments, the electronic device may include a microphone or an accessory having a microphone for enabling a recording mode by which a user may record media. FIG. 6 is a schematic view of an illustrative display screen of a recording mode in accordance with one embodiment of the invention. Display 600 may include content 602 indicating that an audio input is being recorded. Using standard electronic device inputs (e.g., the inputs available from a click-wheel), a user may control some recording mode operations from display 600, including for example enabling or disabling recording and volume. Other operations related to the recording or playback mode, however, may not be easily accessible. FIG. 7 is a schematic view of an illustrative display screen in which contextual selectable options for recording are displayed in accordance with one embodiment of the invention. Display screen 700 may include menu 710 overlaid on or adjacent to content 702. Menu 710 may include some or all of the features described in connection with menu 310 (FIG. 3). Menu 710 may include several options 712 that a user may select by navigating highlight region 714 over the option and providing a selection instruction. Menu 710 may include any suitable option 712, including for example generic options not related specifically to the mode of the electronic device or information displayed underneath menu 710 (e.g., a Cancel option, not displayed). Menu 710 may also include options for operations that are contextually related to the mode of the electronic device. In the example of FIG. 7, menu 710 may include Resume, Stop and Save, and Delete options (e.g., options related to the recording mode of the electronic device).

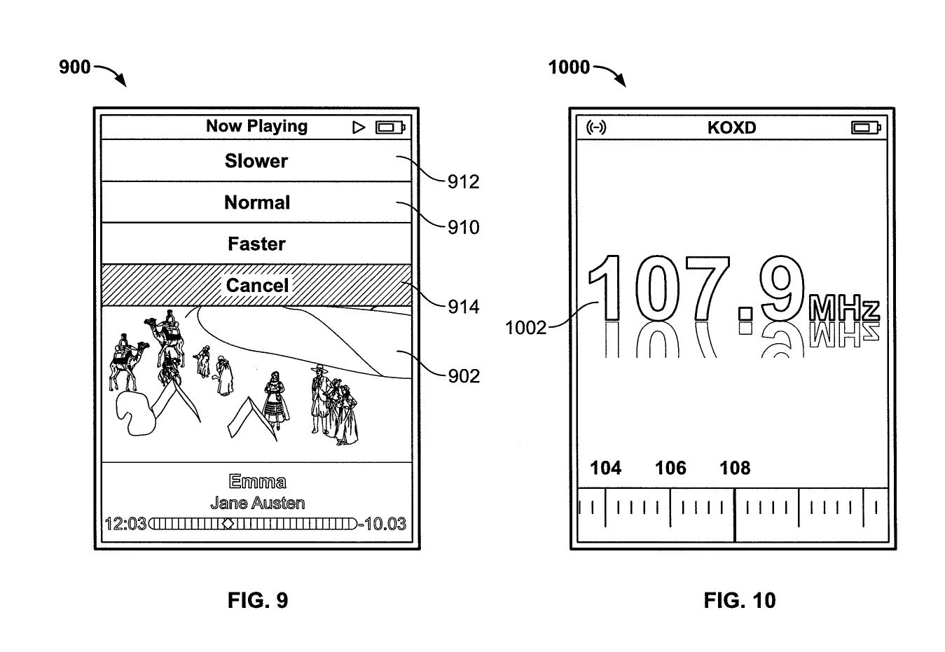

FIG. 8 is a schematic view of an illustrative display screen of an audio book mode in accordance with one embodiment of the invention. Display 800 may include content 802 identifying the particular audio book being played back and the current playback position of the audio book. Using standard electronic device inputs (e.g., the inputs available from a click-wheel), a user may control some audio book mode operations from display 800, including for example pausing or stopping the playback of the audio book and volume controls. Other operations related to the audio book mode, however, may not be easily accessible. FIG. 9 is a schematic view of an illustrative display screen in which contextual selectable options for an audio book are displayed in accordance with one embodiment of the invention. Display screen 900 may include menu 910 overlaid on or adjacent to content 902. Menu 910 may include some or all of the features described in connection with menu 310 (FIG. 3). Menu 910 may include several options 912 that a user may select by navigating highlight region 914 over the option and providing a selection instruction. Menu 910 may include any suitable option 912, including for example generic options not related specifically to the mode of the electronic device or information displayed underneath menu 910 (e.g., a Cancel option). Menu 910 may also include options for operations that are contextually related to the mode of the electronic device. In the example of FIG. 9, menu 910 may include options for different audio book playback speeds (e.g., slower, normal and faster options).

In some embodiments, the electronic device may provide menus with contextual options in a radio mode or application. For example, if the electronic device includes a radio receiver, or if the electronic device is coupled to an accessory that includes a radio receiver, the electronic device may enable a user to access radio broadcasts (e.g., HD radio over a wireless communications link). The electronic device may provide any suitable display to indicate to the user that a radio mode is enabled. FIG. 10 is a schematic view of an illustrative display of a radio mode in accordance with one embodiment of the invention. Display 1000 may include identifier 1002 indicating to the user information for the currently tuned radio station. For example, identifier 1002 may include a radio frequency, radio name or call sign, logo or any other suitable information. In some embodiments, identifier 1002 may include information identifying media being transmitted by the radio station (e.g., a song title and artist name).

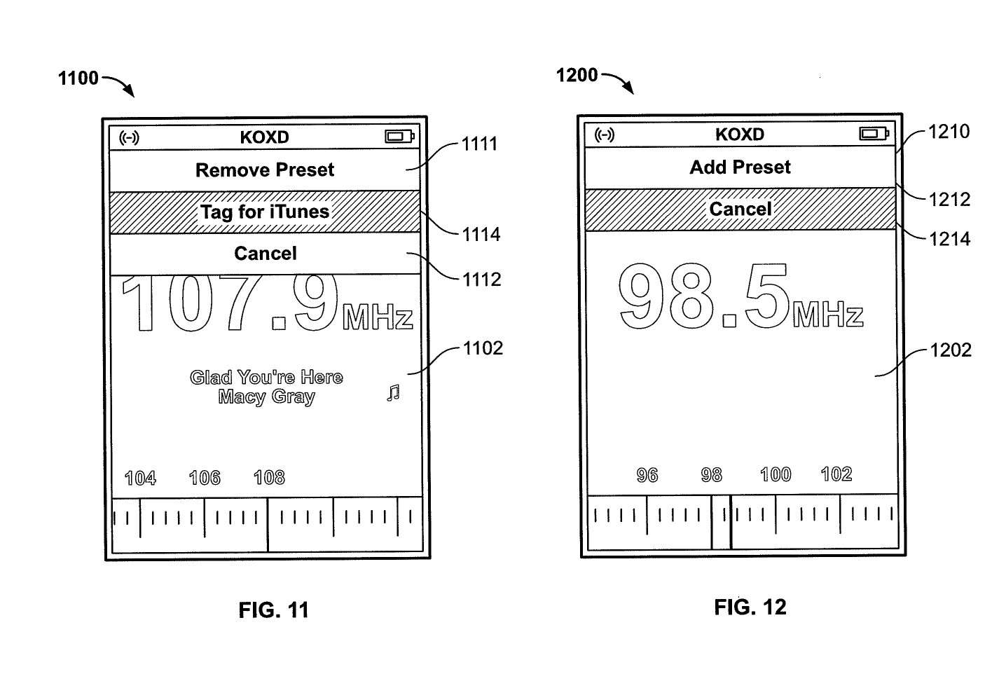

Using standard electronic device inputs (e.g., the inputs available from a click-wheel), a user may control some recording mode operations from display 1000, including for example changing the currently tuned radio station or controlling the volume of the radio. Other operations related to the radio mode, however, may not be easily accessible. FIG. 11 is a schematic view of an illustrative display screen in which contextual selectable options for a radio mode are displayed in accordance with one embodiment of the invention. Display screen 1100 may include menu 1110 overlaid on or adjacent to content 1102. Menu 1110 may include some or all of the features described in connection with menu 310 (FIG. 3). Menu 1110 may include several options 1112 that a user may select by navigating highlight region 1114 over the option and providing a selection instruction. Menu 1110 may include any suitable option 1112, including for example generic options not related specifically to the mode of the electronic device or information displayed underneath menu 1110 (e.g., a Cancel option). Menu 1110 may also include options for operations that are contextually related to the mode of the electronic device. In the example of FIG. 11, menu 1110 may include Tag for iTunes options (e.g., options related to the radio mode and media currently played back). In some embodiments, menu 1110 may include options that are contextually related to a setting of the radio mode. For example, menu 1110 may include a Remove Preset option displayed in response to determining that the currently tuned radio station is selected as a preset. If the electronic device instead determines that the currently tuned radio station has not been selected as a preset, the electronic device may display menu 1210 on display 1200 with a Set Preset option 1212 (FIG. 12).

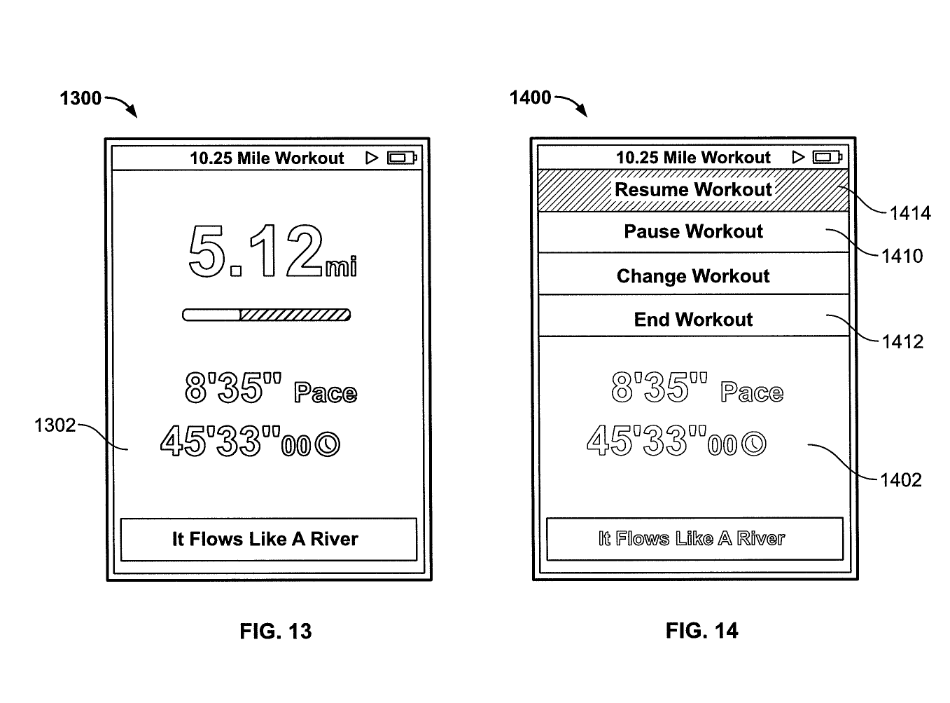

In some embodiments, the electronic device may provide menus with contextual options in a workout mode or application. For example, if the electronic device is coupled to a transmitter carried by the user or on exercise equipment used by the user, the electronic device may enable a user to receive information related to the user's workout from the transmitter. The electronic device may provide any suitable display of workout information to the user. FIG. 13 is a schematic view of an illustrative display of a workout in a workout mode in progress in accordance with one embodiment of the invention. Display 1300 may include workout information 1302 identifying a current workout being conducted, progress of the workout (e.g., the distance run and the time to run the distance), music being played back, or any other suitable information. Because media (e.g., music) may play back as the user operates the electronic device, the standard electronic device inputs (e.g., the inputs available from a click-wheel) may be associated with media playback and not with workout mode operations. To access options for workout mode operations, the electronic device may display a menu with selectable options. FIG. 14 is a schematic view of an illustrative display screen having contextual selectable options for an ongoing workout in a workout mode in accordance with one embodiment of the invention. Display screen 1400 may include menu 1410 overlaid on or adjacent to workout information 1402. Menu 1410 may include some or all of the features described in connection with menu 310 (FIG. 3). Menu 1410 may include several options 1412 that a user may select by navigating highlight region 1414 over the option and providing a selection instruction. Menu 1410 may include any suitable option 1412, including for example generic options not related specifically to the mode of the electronic device or information displayed underneath menu 1410 (e.g., a Cancel option, not shown). Menu 1410 may also include options for operations that are contextually related to the mode of the electronic device. In the example of FIG. 14, menu 1410 may include Resume Workout, Pause Workout, Change Workout, and End Workout options.

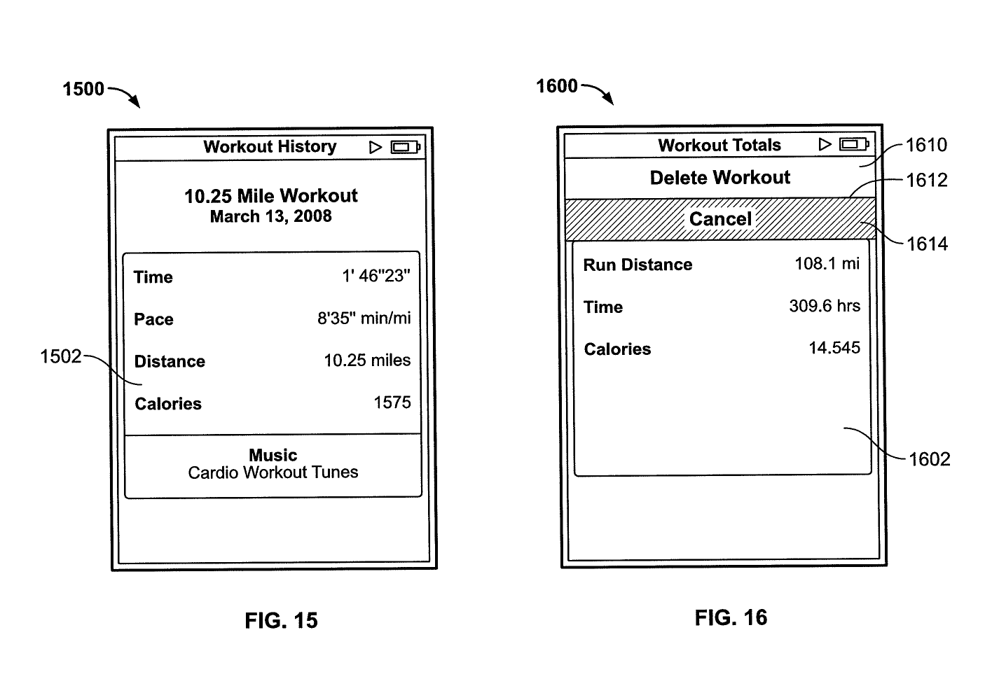

FIG. 15 is a schematic view of an illustrative display of a workout history menu in a workout mode in accordance with one embodiment of the invention. Display 1500 may include workout history information 1502 identifying characteristics of a user's prior workout (e.g., workout duration, pace, distance ran, and calories burned). To avoid confusing a user, the standard electronic device inputs (e.g., the inputs available from a click-wheel) may continue to be associated with media playback while the electronic device is in the workout mode, even if no media is being played back. To access options for workout mode operations, the electronic device may display a menu with selectable options. FIG. 16 is a schematic view of an illustrative display screen having contextual selectable options for a workout history in a workout mode in accordance with one embodiment of the invention. Display screen 1600 may include menu 1610 overlaid on or adjacent to workout information 1602. Menu 1610 may include some or all of the features described in connection with menu 310 (FIG. 3). Menu 1610 may include several options 1612 that a user may select by navigating highlight region 1614 over the option and providing a selection instruction. Menu 1610 may include any suitable option 1612, including for example generic options not related specifically to the mode of the electronic device or information displayed underneath menu 1610 (e.g., a Cancel option). Menu 1610 may also include options for operations that are contextually related to the mode of the electronic device. In the example of FIG. 16, menu 1610 may include a Delete Workout option.

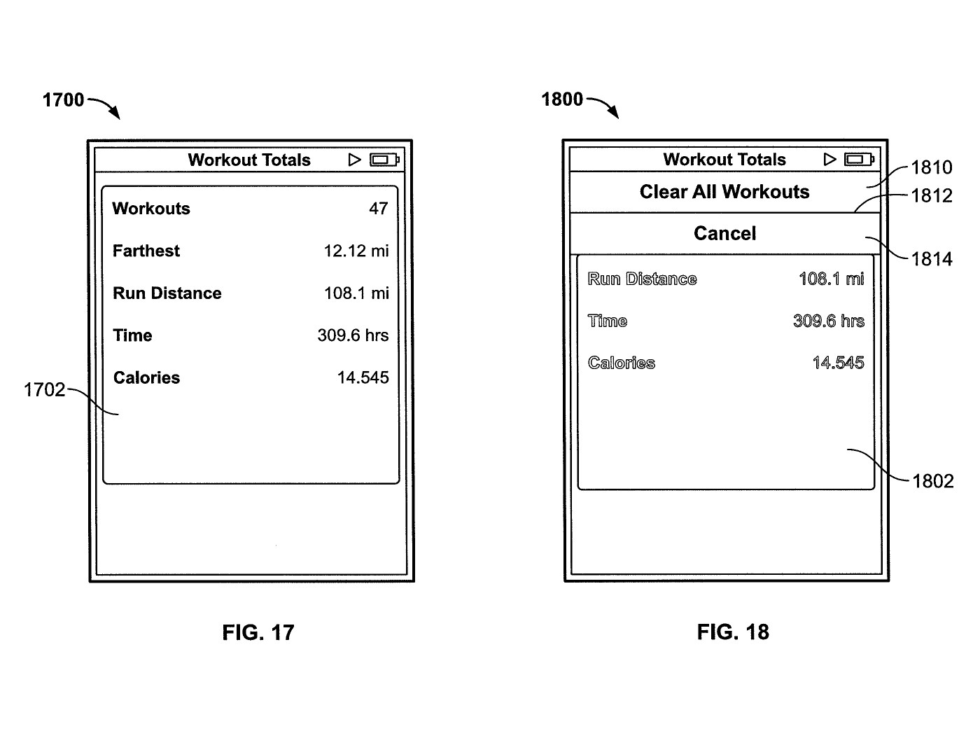

FIG. 17 is a schematic view of an illustrative display of a workout totals menu in a workout mode in accordance with one embodiment of the invention. Display 1700 may include workout history information 1702 identifying characteristics of a user's prior workouts (e.g., number of workouts, farthest run distance, total run distance, and calories burned). To avoid confusing a user, the standard electronic device inputs (e.g., the inputs available from a click-wheel) may continue to be associated with media playback while the electronic device is in the workout mode, even if no media is being played back. To access options for workout mode operations, the electronic device may display a menu with selectable options. FIG. 18 is a schematic view of an illustrative display screen having contextual selectable options for a total workout screen of a workout mode in accordance with one embodiment of the invention. Display screen 1800 may include menu 1810 overlaid on or adjacent to workout information 1802. Menu 1810 may include some or all of the features described in connection with menu 310 (FIG. 3). Menu 1810 may include several options 1812 that a user may select by navigating highlight region 1814 over the option and providing a selection instruction. Menu 1810 may include any suitable option 1812, including for example generic options not related specifically to the mode of the electronic device or information displayed underneath menu 1810 (e.g., a Cancel option). Menu 1810 may also include options for operations that are contextually related to the mode of the electronic device. In the example of FIG. 18, menu 1810 may include a Clear All Workouts option (e.g., to clear all stored or saved workouts).

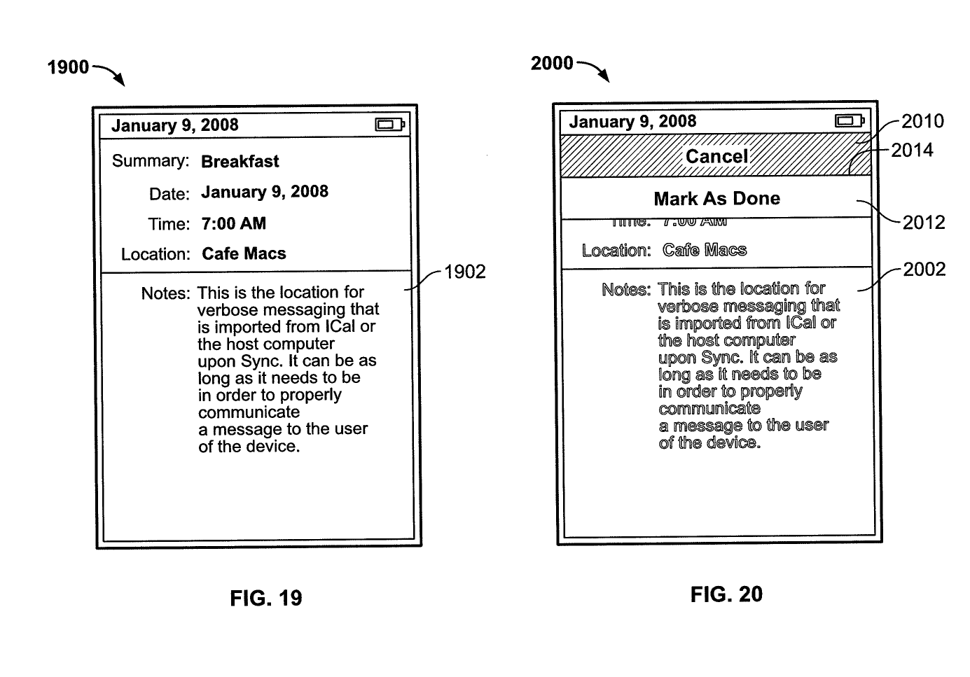

In some embodiments, the electronic device may provide menus with contextual options in a calendar or task mode. For example, the electronic device may include a calendar mode in which a calendar may be synched with a calendar on a host device or in a network cloud (e.g., a calendar on a desktop computer or accessible over the Internet). The electronic device may provide any suitable display of calendar events or tasks to the user. FIG. 19 is a schematic view of an illustrative display screen for viewing a calendar event or task in a calendar or task mode in accordance with one embodiment of the invention. Display 1900 may include event information 1902 describing the event. For example, event information 1902 may include a summary, date, time, location, attendees, notes, or any other suitable information. To access options for calendar or task mode operations, the electronic device may display a menu with suitable selectable options. FIG. 20 is a schematic view of an illustrative display screen having contextual selectable options for an event in a calendar or task mode in accordance with one embodiment of the invention. Display screen 2000 may include menu 2010 overlaid on or adjacent to event information 2002. Menu 2010 may include some or all of the features described in connection with menu 310 (FIG. 3). Menu 2010 may include several options 2012 that a user may select by navigating highlight region 2014 over the option and providing a selection instruction. Menu 2010 may include any suitable option 2012, including for example generic options not related specifically to the mode of the electronic device or information displayed underneath menu 2010 (e.g., a Cancel option). Menu 2010 may also include options for operations that are contextually related to the mode of the electronic device. In the example of FIG. 20, menu 2010 may include a Mark As Done option to indicate that a particular event or task has been completed.

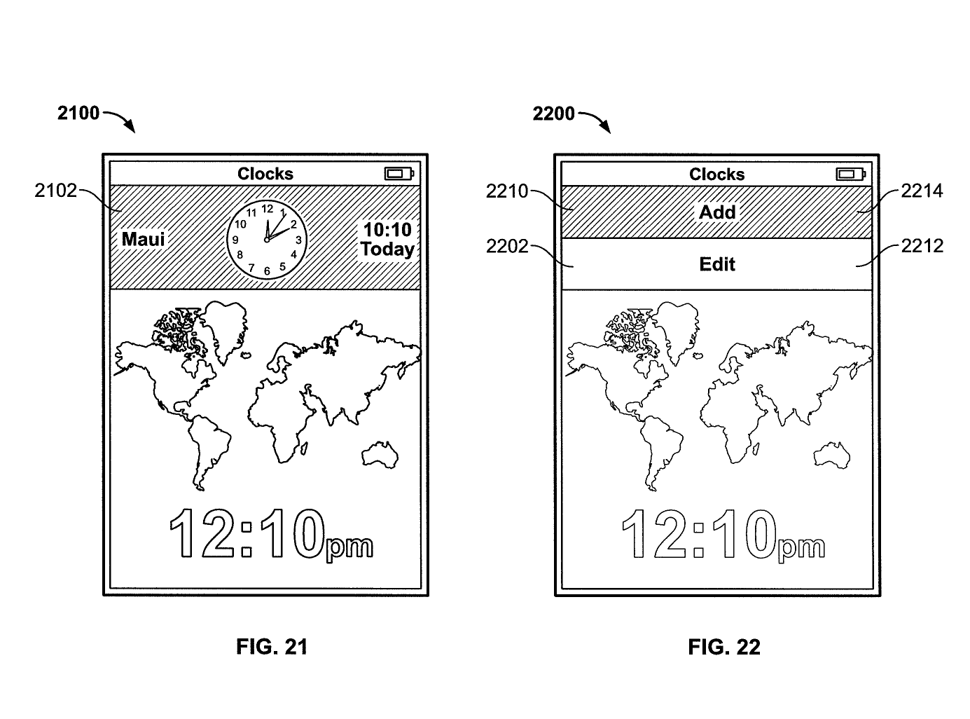

In some embodiments, the electronic device may provide menus with contextual options in a clock mode. The electronic device may provide any suitable display of clocks to the user. FIG. 21 is a schematic view of an illustrative display screen for viewing a clock in a clock mode in accordance with one embodiment of the invention. Display 2100 may include clock 2102 identifying the current time for a particular location (e.g., Maui). To access operations for a single clock in a clock mode, the electronic device may display a menu with suitable selectable options. FIG. 22 is a schematic view of an illustrative display screen having contextual selectable options for a single displayed clock in accordance with one embodiment of the invention. Display screen 2200 may include menu 2210 overlaid on or adjacent to clock 2202. Menu 2210 may include some or all of the features described in connection with menu 310 (FIG. 3). Menu 2210 may include several options 2212 that a user may select by navigating highlight region 2214 over the option and providing a selection instruction. Menu 2210 may include any suitable option 2212, including for example generic options not related specifically to the mode of the electronic device or information displayed underneath menu 2210 (e.g., a Cancel option). Menu 2210 may also include options for operations that are contextually related to the mode of the electronic device. In the example of FIG. 22, menu 2210 may include an Add option to add an additional clock to display 2100 (FIG. 21) and an Edit option to change the settings of an existing clock (e.g., clock 2102, FIG. 21).

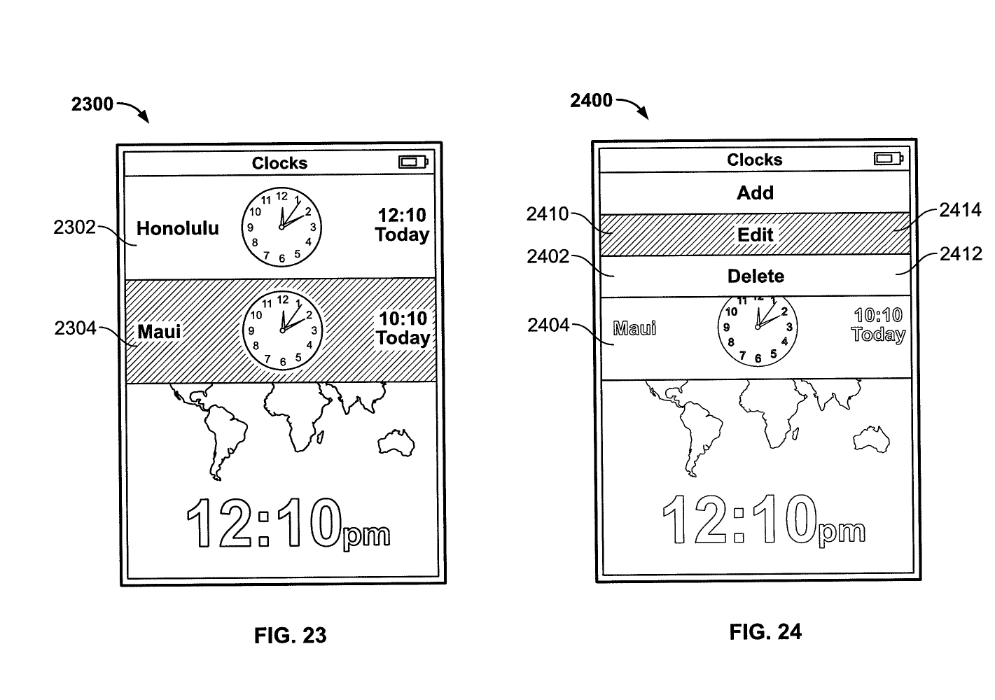

Similarly, FIG. 23 is a schematic view of an illustrative display screen for viewing several clocks in a clock mode in accordance with one embodiment of the invention. Display 2300 may include clocks 2302 and 2304 identifying the current time for particular locations (e.g., Maui and Honolulu). To access operations for several clocks in a clock mode, the electronic device may display a menu with suitable selectable options. FIG. 24 is a schematic view of an illustrative display screen having contextual selectable options for several displayed clocks in accordance with one embodiment of the invention. Display screen 2400 may include menu 2410 overlaid on or adjacent to clocks 2402 (not shown) and 2404. Menu 2410 may include some or all of the features described in connection with menu 310 (FIG. 3). Menu 2410 may include several options 2412 that a user may select by navigating highlight region 2414 over the option and providing a selection instruction. Menu 2410 may include any suitable option 2412, including for example generic options not related specifically to the mode of the electronic device or information displayed underneath menu 2410 (e.g., a Cancel option). Menu 2410 may also include options for operations that are contextually related to the mode of the electronic device. In the example of FIG. 24, menu 2410 may include an Add option to add an additional clock to display 2300 (FIG. 23) and a Delete option for removing one of the several displayed clocks.

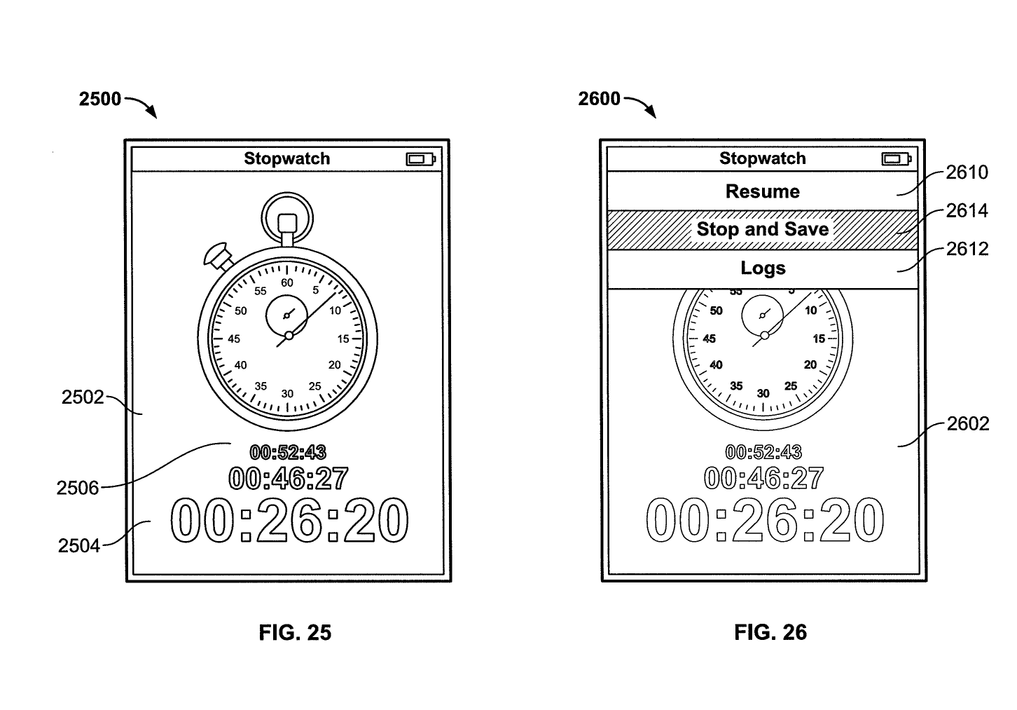

In some embodiments, the electronic device may provide menus with contextual options in a stopwatch mode or application. FIG. 25 is a schematic view of an illustrative display screen showing a stopwatch in a stopwatch mode in accordance with one embodiment of the invention. Display 2500 may include stopwatch 2502 with a running timer 2504 indicating the delay since stopwatch 2502 was initiated. In some embodiments, display 2500 may include previously saved timers 2506 indicating the timed delays of prior saved usages of the stopwatch (e.g., previously timed laps). To access options for controlling the stopwatch, the electronic device may display a menu with suitable selectable options. FIG. 26 is a schematic view of an illustrative display screen having contextual selectable options for a stopwatch mode in accordance with one embodiment of the invention. Display screen 2600 may include menu 2610 overlaid on or adjacent to clock 2602. Menu 2610 may include some or all of the features described in connection with menu 310 (FIG. 3). Menu 2610 may include several options 2612 that a user may select by navigating highlight region 2614 over the option and providing a selection instruction. Menu 2610 may include any suitable option 2612, including for example generic options not related specifically to the mode of the electronic device or information displayed underneath menu 2610 (e.g., a Cancel option, not shown). Menu 2610 may also include options for operations that are contextually related to the mode of the electronic device. In the example of FIG. 26, menu 2610 may include Resume, Stop and Save, and Logs options.

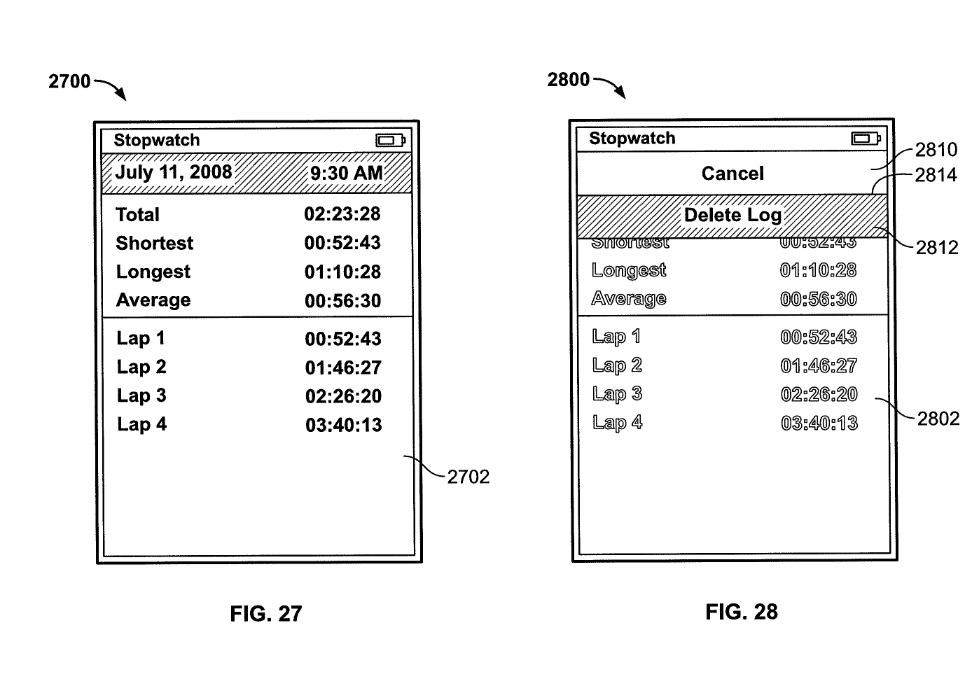

In some embodiments, the electronic device may allow a user to view logs of stopwatch times (e.g., to view average lap times). For example, the user may select a Logs option displayed in a contextual menu (e.g., a Logs option in menu 2610, FIG. 26). FIG. 27 is a schematic view of an illustrative display screen showing a stopwatch log in a stopwatch mode in accordance with one embodiment of the invention. Display 2700 may include log 2702 indicating previous or saved stopwatch times. Log 2702 may organize the saved stopwatch times using any suitable approach, including for example in laps (e.g., displayed laps 1-4). Log 2702 may instead or in addition include summary information, for example the average, shortest, and longest stopwatch timers. To access options for editing the stopwatch log, the electronic device may display a menu with suitable selectable options. FIG. 28 is a schematic view of an illustrative display screen having contextual selectable options for editing a stopwatch log in accordance with one embodiment of the invention. Display screen 2800 may include menu 2810 overlaid on or adjacent to log 2802. Menu 2810 may include some or all of the features described in connection with menu 310 (FIG. 3). Menu 2810 may include several options 2812 that a user may select by navigating highlight region 2814 over the option and providing a selection instruction. Menu 2810 may include any suitable option 2812, including for example generic options not related specifically to the mode of the electronic device or information displayed underneath menu 2810 (e.g., a Cancel option). Menu 2810 may also include options for operations that are contextually related to the mode of the electronic device. In the example of FIG. 28, menu 2810 may include a Delete Log option.

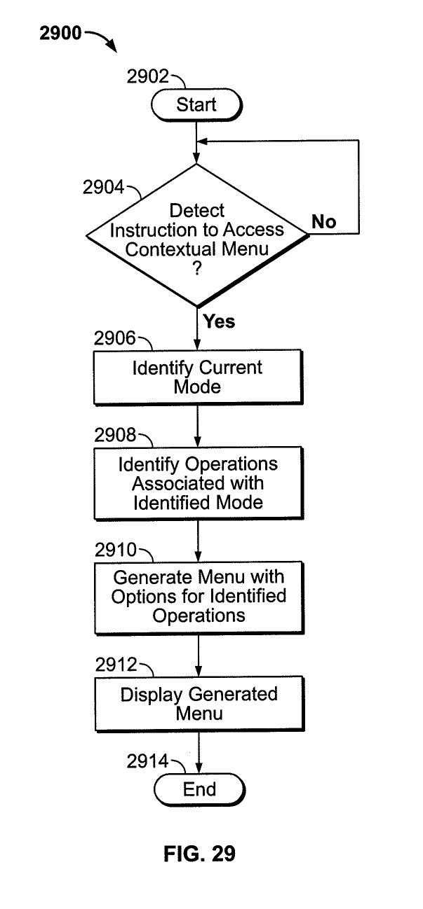

The following flowchart will describe an illustrative process for identifying and displaying a contextual menu associated with a mode of an electronic device. FIG. 29 is a flow chart of an illustrative process for displaying a contextual menu associated with a current mode in accordance with one embodiment of the invention. Process 2900 may begin at step 2902. At step 2904, the electronic device may determine whether an instruction to access a contextual menu was received. For example, the electronic device may determine whether an input associated with a contextual menu was provided using the input mechanism (e.g., a long button press of a click-wheel center button or menu button). If the electronic device determines that no instruction to access contextual menu was received, process 2900 may return to step 2904 and continue to monitor inputs received by the electronic device.

If, at step 2904, the electronic device instead determines that an instruction to access a contextual menu was received, process 2900 may move to step 2906. At step 2906, the electronic device may identify the current mode of the electronic device. For example, the electronic device may identify a state of the device and determine the mode associated with the current state. As another example, the electronic device may track the mode of the electronic device and store the mode in memory. As still another example, the electronic device may determine the mode from the one or more applications in use or processes running on the electronic device. The electronic device may have any suitable number or types of modes, including for example media, recording, audio book, radio, workout, calendar, event, clock, stopwatch modes, or any other suitable mode. At step 2908, the electronic device may identify operations associated with the identified mode. For example, the electronic device may identify operations associated with the identified mode that the user cannot access by simple inputs on the input mechanism (e.g., operations that are not controlled by a selection of a click-wheel button).

At step 2910, the electronic device may generate a menu that includes an option for at least one of the identified operations. For example, the generated menu may include generic options (e.g., applicable to all modes, such as a Cancel option) and context specific options for operations related to a particular mode (e.g., Browse Artist, Add to Presets, or Stop and Save). At step 2912, the electronic device may display the generated menu. For example, the electronic device may provide an animation to display the generated menu to the user. As another example, the electronic device may modify the display attributes of the content underneath the display (e.g., change the lighting or transparency) to bring the user's attention to the menu. The menu may be displayed using any suitable approach, including for example as an overlay, in a new screen or display, as a pop-up, or using any other suitable approach. Process 2900 may then end at step 2914.

It will be noted that any other suitable mode of the electronic device may include contextual menus displayed in response to a user instruction, and that the modes and menus described above are merely illustrative and not exhaustive or limiting. The present invention is limited only by the claims which follow.

What is claimed is:

1. A method for displaying a menu with selectable contextual options using a portable electronic device, comprising:
displaying non-selectable content associated with a current mode of an electronic device, wherein the current mode comprises at least one of media, recording, audio book, radio, workout, calendar, event, clock, and stopwatch modes;
detecting the current mode;
identifying at least one option associated only with the detected current mode;
generating a menu comprising the identified at least one option; and
overlaying the generated menu on the displayed content associated with the identified current mode such that at least a portion of the content remains visible.

2. The method of claim 1, wherein overlaying further comprises:
darkening the displayed content.

3. The method of claim 2, wherein overlaying further comprises:
displaying a shadow around the menu.

4. The method of claim 3, wherein overlaying further comprises:
animating the addition of the menu to the display.

5. The method of claim 4, wherein animating comprises expanding the menu from a single point at the edge of the display.

6. The method of claim 1, further comprising:
receiving a user instruction to access a menu comprising at least one option associated with only the current mode; and
detecting, identifying, generating and displaying in response to receiving.

7. The method of claim 6, wherein receiving further comprises detecting a single extended press of a button.

8. The method of claim 7, wherein the button is a button of a click-wheel.

9. A portable electronic device operative to display a menu, comprising a processor, a display, an input mechanism, the processor operative to:
direct the display to display content associated with a particular mode of the electronic device;
receive an indication from the input mechanism that an input was received from the user, wherein the input is not associated with a selectable option displayed by the display;
detect the particular mode;
identify at least one operation associated only with the particular mode; and
direct the display to display a menu comprising an option for the at least one operation.

10. The portable electronic device of claim 9, wherein the particular mode comprises at least one of:
a media mode;
a recording mode;
an audio book mode;
a radio mode;
a workout mode;
a calendar mode;
an event mode;
a clock mode; and
a stopwatch mode.

11. The portable electronic device of claim 10, wherein:
the particular mode comprises a media mode; and
the processor is further operative to identify at least one of browsing an artist, browsing an album, playing back media by an artist, playing back an album, and adding media to a playlist.

12. The portable electronic device of claim 10, wherein:
the particular mode comprises a recording mode; and
the processor is further operative to identify at least one of resuming, stopping and saving, and deleting.

13. The portable electronic device of claim 10, wherein:
the particular mode comprises an audio book mode; and
the processor is further operative to identify at least one of playing back slower, playing back at normal speed, and playing back faster.

14. The portable electronic device of claim 10, wherein:
the particular mode comprises a radio mode; and
the processor is further operative to identify at least one of tagging media for purchase, adding a preset, and removing a preset.

15. The portable electronic device of claim 10, wherein:
the particular mode comprises a workout mode; and
the processor is further operative to identify at least one of resuming a workout, pausing a workout, changing a workout, ending a workout, deleting a workout, and clearing all stored workouts.

16. The portable electronic device of claim 10, wherein:
the particular mode comprises a calendar mode; and
the processor is further operative to identify marking an event as done.

17. The portable electronic device of claim 10, wherein:
the particular mode comprises a clock mode; and
the processor is further operative to identify at least one of adding a new clock, editing a clock, and deleting a clock.

18. The portable electronic device of claim 10, wherein:
the particular mode comprises a stopwatch mode; and
the processor is further operative to identify at least one of resuming, stopping and saving, accessing logs, and deleting a log.

19. The portable electronic device of claim 10, wherein the processor is further operative to direct the display to overlay the menu on the displayed content such that at least a portion of the content remains visible around the menu.

20. A computer-readable media operative to display a menu with selectable contextual options using a portable electronic device, the computer readable media comprising computer program logic recorded thereon for:
displaying non-selectable content associated with a current mode of an electronic device, wherein the current mode comprises at least one of media, recording, audio book, radio, workout, calendar, event, clock, and stopwatch modes;
detecting the current mode;
identifying at least one option associated only with the detected current mode;
generating a menu comprising the identified at least one option; and
overlaying the generated menu on displayed content associated with the identified current mode such that at least a portion of the content remains visible.

21. A method for displaying a contextual menu using a portable electronic device, comprising:
displaying content associated with a current mode of an electronic device, wherein the current mode comprises at least one of media, recording, audio book, radio, workout, calendar, event, clock, and stopwatch modes;
detecting the current mode;
identifying at least one menu option associated only with the detected current mode;
generating a menu comprising the identified at least one option;
overlaying the generated menu on the displayed content, wherein the overlayed menu includes a drop shadow; and
changing the transparency and luminosity of the displayed content.
